(19) United States
(12) Patent Application Publication
(10) Pub. No.: US 2009/0319564 A1
(43) Pub. Date: Dec. 24, 2009

(54) Intentionally-Linked Entities: A General-Purpose Database System

(76) Inventor: Vitit Kantabutra, Pocatello, ID (US)

Correspondence Address: Vitit Kantabutra, 8121 West Buckskin Road, Pocatello, ID, 83201, US

(21) Appl. No.: 12/490,270

(22) Filed: Jun. 23, 2009

Related U.S. Application Data
(60) Provisional application No. 61/075,189, filed on Jun. 24, 2008.

(51) Int. Cl. G06F 17/30

(52) U.S. Cl. 707/103 R; 707/E17.055

(57) ABSTRACT

In accordance with one embodiment the subject of the patent is a method for storing a database comprising entity objects or data structures representing the data entities, and relationship objects or data structures representing the relationships amongst the entities. Each relationship object or data structure possesses links to the entity objects or data structures that play the various roles in the relationship. Where there is a link from a relationship to an entity, there is also a link from the entity to the relationship, facilitating queries and updates to the database system. It is possible and often desirable for an embodiment to permit not merely one, but possibly many (or zero) entities to play each role in a relationship. The database is value-oriented in the sense that the address of an entity is not part of the key, thus permitting value-comparison-based searches.

### CROSS-REFERENCE TO RELATED APPLICATIONS

This application claims the benefit of provisional patent application Ser. No. 61/075,189, filed Jun. 24, 2008 by the present inventor.

### OTHER RELEVANT APPLICATIONS

U.S. Pat. No. 7,483,920 Jan. 27, 2009 Mori, et al.: Database management system, database management method, and program
U.S. Pat. No. 7,333,986 Feb. 19, 2008 Minamino, et al.: Hierarchical database management system, hierarchical database management method, and hierarchical database management program
U.S. Pat. No. 6,633,886 Oct. 14, 2003 Chong: Method of implementing an acyclic directed graph structure using a relational database

### OTHER REFERENCES

C. J. Date and E. F. Codd, “The Relational and Network Approaches: Comparison of the Application Programming Interfaces,” in ACM SIGFIDET (now SIGMOD) workshop on Data description, access and control, 1974.

J. D. Ullman, Principles of Database and Knowledge-Base Systems, Vol. 1, Computer Science Press, 1988.

H. F. Korth and A. Silberschatz, Database System Concepts, second edition, McGraw-Hill, 1991.

H. Garcia-Molina, J. D. Ullman, and J. Widom, Database Systems: The Complete Book, second edition, Prentice-Hall, 2009.

University of Illinois, Urbana-Champaign database tutorial found at http://mias.uiuc.edu/files/tutorials/kcchang01.ppt

Introductory information on database management systems at http://www.scribd.com/doc/4355522/dbms

### FEDERALLY SPONSORED RESEARCH

Not applicable.

### BACKGROUND

1. Field of the Invention

This application relates to database systems, specifically to database systems in which there are data entities that have relationships amongst one another.

2. Prior Art

All but the most trivial databases comprise data entities of various sorts and interrelationships among them. For example, databases of social or political networks, technical systems, movie production networks, university information, and virtually all other non-trivial database systems involve entities and their interrelationships. Naive users might store information in text files or spreadsheets. More sophisticated users might turn to Relational database systems. Heretofore the best known ways to store databases involving entities and their interrelationships are, (1) Relational Databases, (2) Object-Oriented Databases, including variations like Object-Relational Databases, (3) XML, and (4) Hierarchical and Network Databases, these last types considered mostly obsolete. None of these is really satisfactory for storing data about systems of any complexity in terms of the interrelationships amongst data entities. Relational Databases have a high level of built-in data redundancy that invites errors and inconsistencies. These shortcomings can make the design of a good database schema difficult, and can even make the simple act of data entry very annoying. Object-Oriented databases and the like only directly support simple relationships and can be hard to use, accounting for their lack of popularity. XML imposes an hierarchy on the entities, and only allows limited breakaway from the hierarchy with any degree of convenience. Additionally, pointers indicating the non-hierarchical relationships are represented as text rather than true pointers.

Like XML, Hierarchical databases are oriented towards hierarchical relationships amongst data entities rather than more general relationships.

Network databases permit non-hierarchical relationships more natively, but are still hard to use because it is oriented towards binary, many-to-one relationships, requiring more general relationships to be available only by simulation. Additionally, querying a Network database is an exercise in “manual” (programmed) physical navigation of the network, which means that any update to the database requires code update as well. The query language is procedural rather than declarative like SQL.

We need to spend more attention to Relational and Network databases in our discussion of prior art. Relational databases need to be examined in more detail because it is still the predominant type of database, and hence is so readily available that it is used even in inappropriate circumstances. Network databases, on the other hand, needs to be examined in detail because it is the closest to what we are proposing to patent here, though also significantly different as we will point out.

The Relational database scheme certainly has the advantage of simplicity over all the others except for the flat file database, which is not discussed here. As Codd, its inventor, stated, the only concept the user really has to know to begin using Relational databases is that of a two-dimensional table. Every data entity is represented merely by something that can be written into one or more table entries, such as a character string (a name, perhaps) or a number (I.D.), or a combination of a string and a number, for example. Often, such simplicity works very well in practice. However, real-world databases get complex very quickly, and often such simplicity doesn't work any more, as we will now see through a real example.

Our sample application is to store a database about a network of merchants and their clients in Mediaeval Spain. The source of our data is a set of notarized documents or contracts, each representing some kind of business transaction from the 1500's. In each business transaction, there was one or more merchants acting as servers or service providers and zero or more clients. In case there is exactly one server and one client, the transaction is easily represented as a row in a Relational database. However, even in this case there is a potential for errors due to mistyping. For instance, if each person's name (or an ID number) is used as a key, and it is misspelled or mistyped. Such an act of misspelling or mistyping amounts to the creation of a new person entity. This is an important flaw in Relational databases—it is caused by the fact that something as important as an entity (a person, no less!) is represented by a mere character string (or an ID number).

Another problem arises when we try to use a Relational database if the numbers of servers and clients can vary, as they do in the actual application under consideration. Relational database tables can't have a variable number of columns. One solution is to have enough columns to accommodate the maximum number of columns we will ever need. This is a poor solution, because it leads to a large number of NULL entries.

Another well-known problem with Relational database tables is data redundancy, which often leads to data incoherence as well as errors caused by mistyping. Some of that can be removed by means of a process called normalization, which splits up a table into two or more tables. However, normalization can be quite complicated and hard to understand, defeating one major advantage, that of simplicity, touted by Relational DBMS' creator and proponents. In fact, in business practice few users even know much about database schema normalization techniques.

There is yet another cause for the complexity of Relational databases, belying the advertised simplicity. The proponents claim that there are nothing but values in tables, but in fact for the sake of efficiency pointers are needed, just like they are needed in other kinds of DBMS'. For example, indexes are needed for efficient searches, and indexes require large numbers of pointers. Additionally, pointers are often required for the storage of data on media such as disks.

In summary, Relational databases are simple, but only to a casual user who does not intend to use them for a complex project where a great deal of efficiency or reliability is required.

We will now turn to examining the Network DBMS. The Network DBMS uses pointers, also called links or references, to represent binary, many-to-one relationships amongst entities, which in turn are represented by records. General relationships (many-to-many or those with arities greater than 2) can also be represented, but only by simulation.

As shown in FIG. 8, a many-to-one relationship is represented with a cyclical chain of pointers. All the records in the chain form a “set.” In that set, there is a unique entity in the “one” of the many-to-one relationship. This unique entity is called the “owner” of the set, whereas all the other entities, those of the “many,” are called the “members” of the set. There is a direct link from the owner of the set to only one of the members, and likewise only one of the members has a direct link to its owner in the set. This makes for inefficient searches. Note, though, that proponents of Network databases thought that Network databases are often more efficient than Relational databases because of the links in the former. But the links in Networks DBMS's can be quite indirect, which means that searches in ILE, with its links being more direct, should be generally more efficient than in either of the other two types of databases.

Searches in a Network database is done by means of pointer navigation or traversal. Such navigation is done by procedural, not declarative, code, and must be explicitly programmed by the application programmer. This is not only difficult because the application programmer has to know the exact structure of the database, but it also means that any change in the database could be bad news, because it frequently requires code change!

Additionally, even simple queries may require traversing practically the entire network of records [6]. There is no automatic, easy-to-use search facility in Network databases.

### DRAWINGS—FIGURES

FIG. 1 shows an embodiment of an entire Intentionally-Linked Entities (ILE) Database system.

FIG. 2 shows a data structure or object representing an ILE database according to an embodiment.

FIG. 3 shows a data structure or object representing an entity set in an ILE database according to an embodiment.

FIG. 4 shows a data structure or object representing an entity in an ILE database according to an embodiment.

FIG. 5 shows a data structure or object representing a relationship set in an ILE database.

FIG. 6 shows a data structure or object representing an “entity set plus” (ESP). An ESP data structure or object comprises the entity set as well as the names and types of per-relationship attributes of the entities in the entity set.

FIG. 7 shows a relationship data structure or object, as represented in an embodiment as an array of arrays of elements, where each element is a reference to an ESP object shown in the previous figure.

FIG. 8 (prior art) shows how a many-to-one relationship between entities is defined in a Network database. In a Network database, only many-to-one, binary relationships are implemented directly without simulation. Such a relationship is implemented with a circular linked list as shown in this figure. There is no direct link from the “Harrison” student record to the “MA235” enrollment record. Note that many real databases have many-to-one and/or non-binary relationships, making Network databases hard to use. Even this example here, which is similar to one from a written source, is unrealistic as it stands because only one student can be enrolled in each course! (Note that in fact, direct implementation of a relationship is only permitted if the “many” and the “one” records are of different types. That is, even a many-to-one, binary relationship must be simulated if the records of the “many” and the “one” are of the same type. This helps to make Network databases difficult to program.)

### DRAWINGS—REFERENCE NUMERALS

10 Set of all database sets.
20, 20′ Database sets.
30, 30′ Databases.
31 Database name (or a reference thereto)
32 A data structure of entity sets or a reference thereto. In an embodiment, such a structure is a hash of entity set references. The entity set name is used as the hash key to aid searches.
33 A data structure of relationship sets or a reference thereto. In an embodiment, such a structure is a hash of relationship set references. The relationship set name is used as the hash key to aid searches.
34 An optional data structure that may be used to store any useful information pertaining to the database.
40 Set of all the entity sets in the database.
50, 50′ Entity sets.
51 Entity set name or a reference thereto.
52 A reference to the database this entity set belongs to.
53 An ordered data structure (can be embodied as a dynamically-allocated array) representing all the names (and optionally types) of key attributes. Note that in ILE, there are no hidden key implied by the storage location of an object as there was in Network databases. In this sense ILE is “value-oriented” rather than “object-oriented.”
54 An ordered data structure (can be embodied as a dynamically-allocated array) representing all the names (and optionally types) of non-key attributes.
55 A data structure or object containing all the entities belonging to this entity set, or a reference to such a data structure or object.
56 References to all the relationship sets containing the relationships in which the entities belonging to this entity set are involved.
57 Optional data structure that may be used to store any useful information pertaining to the entity set.
58 “Entity Set Plus,” comprising an entity set data structure object as well as a data structure or object representing the names and types of attributes that pertain to both the entity and the relationship, also called the “per-relationship attributes” of an entity.
59 Name and type of per-relationship attributes.
60 Set of all relationship sets in the database.
70 Relationship set
71 A relationship set name or a reference thereto.
72 A reference to the current database, that is, the database of which this relationship set is a part
73 An ordered composite data structure, such as an array, of composite data structure such as an array of “entity set plus” objects or data structures, where an “entity set plus” object or data structure comprises an entity set and the per-entity attributes pertaining to how each entity in the relevant entity set enters a relationship in this relationship set.
74 Names and types of relationship attributes, arranged into an ordered data structure such as a dynamically allocated array.
80, 80′, 80″ Entities
81 A reference to the entity set to which this entity belong.
82 A data structure or object representing the key attributes of this entity. A hash keyed by attribute names is used in an embodiment of ILE.
83 A data structure or object representing the non-key attributes of this entity. A hash keyed by attribute names is used in an embodiment of ILE.
84 References to the relationships in which this entity is involves. Included are means for indicating which role in each such relationship this entity plays.
88 “entity plus,” comprising an entity data structure or object plus attributes pertaining to this entity as it enters into a particular relationship. These attributes are determined by both the particular entity and the particular relationship.
90, 90′ Relationships.
95 An element of an array of arrays in a relationship data structure or object according to one embodiment. This element contains a reference to an “entity-set plus” (ESP) object which is described above.
100 A student record in a Network database.
110, 110′ Enrollment records in a Network database.
R0, R5, R0′ array elements containing pointers to entities playing roles 0 and 5, respectively.

### DETAILED DESCRIPTION

The subject of this patent is a new kind of database management system called Intentionally-Linked Entities, or ILE. In ILE, relationships among entities will be represented directly as true links among them. Thus general graphs (as in Graph Theory), and in fact more (to be explained below), can be represented naturally. The data model will be similar to the Entity/Relationship data model, which was never implemented very well in the prior art partly due to the lack of good programming tools such as object-oriented languages and simple-to-use dynamic memory allocation. (The most valiant attempt in the past was the flopped Network Databases discussed earlier in this document.) However, at the present time sufficient tools and programming languages have been developed so that complex linked data structures are now in more widespread use. Complex linked data structures are used in operating system kernels, for example. Interestingly enough, complex linked data structures have not been used in the database field except in index structures. The main idea behind the ILE database system is to use modern linked data structures, dynamically-allocated arrays, hashes, and objects in general in the main arena of database storage to the fullest extent possible.

What was meant above by saying that we can represent more than just general graphs in ILE? In a graph, an edge represents a binary relationship, that is, a relationship between two nodes, where the nodes commonly represent entities. In ILE, relationships with arities greater than two are possible, and in fact are convenient to create and naturally represented. Thus ILE data structures are more powerful than general graphs. In fact, in ILE, we can also store a new kind of attribute that pertain not to entities in a static way, but that pertain to the entities as they enter a specific relationship. These extra capabilities of ILE are important in the application of ILE to complex networks such as the ones to be referred to in the next paragraph.

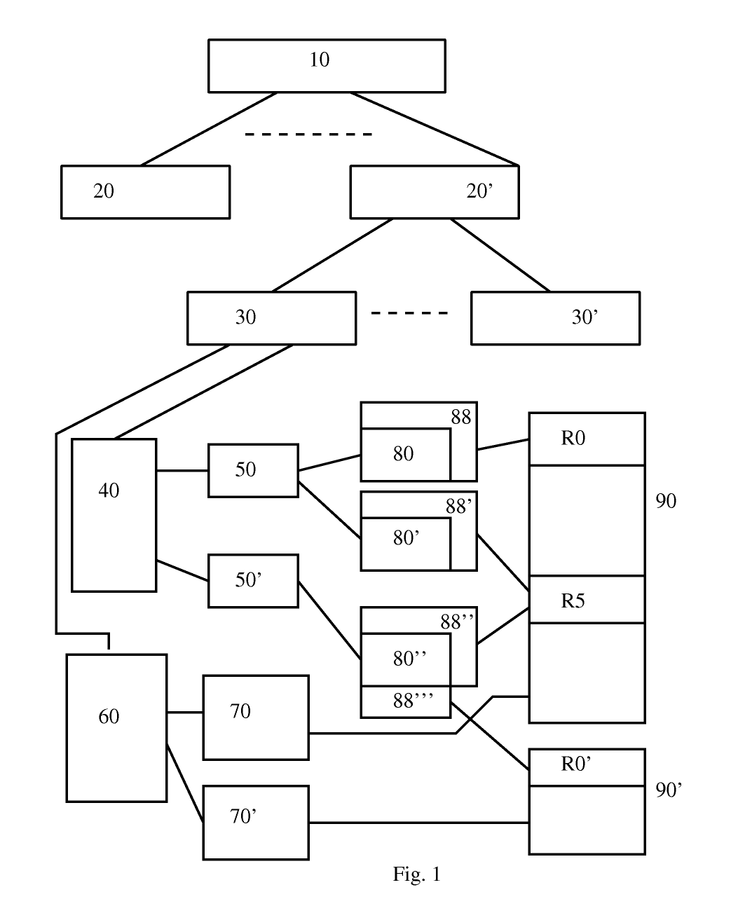

We now turn to a more detailed description of ILE, as shown in FIG. 1. Reference 10 is an entire ILE system, which can contain an arbitrary number of databases. The idea is that in ILE, we can enable the various databases in the system to communicate (share data) with each other. The system is divided into database sets, references 20 and 20′, with the idea that it is possible to permit databases in the same set to communicate with each other, but that we could optionally disallow communications across different sets. In fact a more complex tree of databases may prove useful, but that is off topic for this patent. In each database set, say reference 20′, there can be an arbitrary number of databases. In FIG. 1, references 30 and 30′ are two databases in the same database set 20′. From now on we will just concentrate on one database, say reference 30′.

A database includes a data structure or object such as a hash that contains or holds references to all the entity sets (reference 40), which are data structures or objects that represents sets of data entities, such that all the entities in each such set are of the same kind. For example, in a university database all entities representing students could be in a single entity set.

A database also includes a data structure or object that contains or hold references to all the relationship sets (reference 60), which are data structures or objects that represent sets of relationships of like kind. For example, all the relationships between two people of the form “is the father of” form one relationship set.

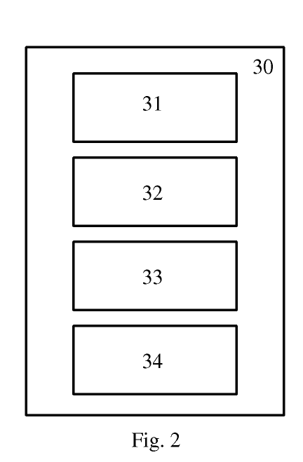

FIG. 2 shows the contents of a database object in more detail. The data structures of entity set and of relationship sets mentioned in the previous two paragraphs are shown as references 32 and 33 in FIG. 2. Ref. 31 is the database name or a reference thereto. Ref. 34 is optional information (or a link thereto), such as notes about the database.

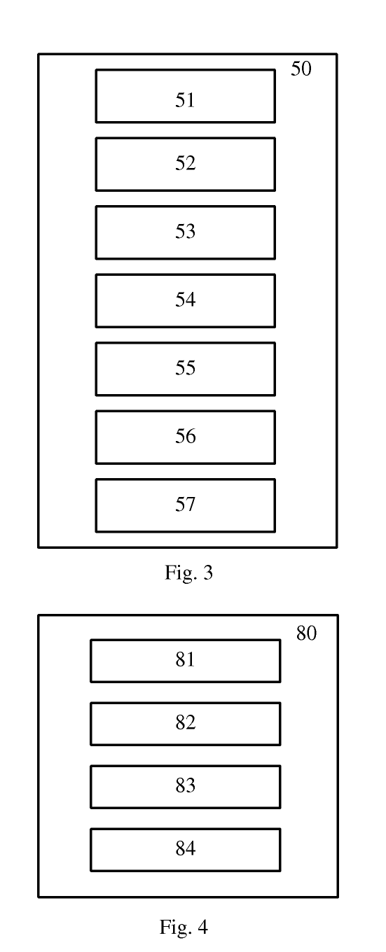

Now we look into an embodiment of a data structure or object that holds an entity set, which is shown as references 50 and 50′ in FIG. 1. Referring to FIG. 3. Ref. 51 is the name of the entity set, or a reference thereto. Ref. 52 is a reference to the database to which this entity set belong. This is not necessary, but can make some operations more convenient. Ref. 53 is an ordered data structure (such as an array, dynamically allocated) of the key attribute names and types.

Much as ILE uses modern objects for its implementation, and is object-oriented in the sense that it can be embodied to permit objects as data entities, it is not an object-oriented database like Network databases, as in the sense used in Ullman [2] but is instead value-oriented like Relational databases. That is, ILE does not use storage location as key, but uses key attribute values as key instead.

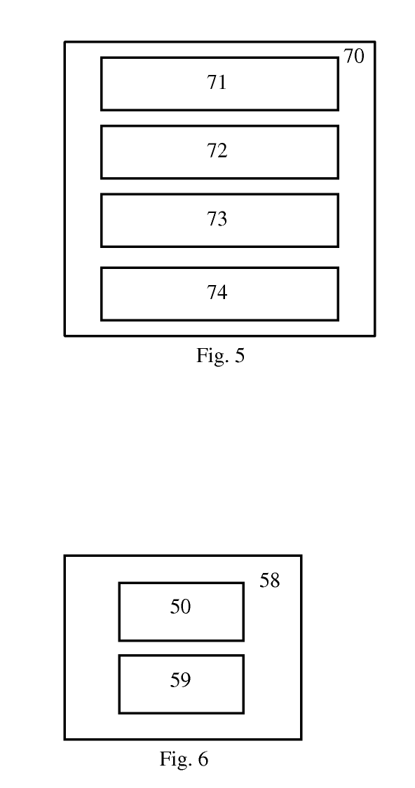

Back to FIG. 1, Ref. 60 is a data structure that holds (a reference to) all the relationship sets in the current ILE database. Ref. 70 and 70′ are sample relationship sets. FIG. 5 shows a relationship set as implemented in an embodiment. Ref. 71 is the relationship set name or a reference thereto. Ref. 72 is a reference to the current database. Ref. 73 is an ordered composite data structure, such as an array, of composite data structure such as an array of “entity set plus” objects or data structures, where an “entity set plus” object or data structure comprises an entity set and the per-entity attributes pertaining to how each entity in the relevant entity set enters a relationship in this relationship set. Ref. 74 contains names and types of relationship attributes, arranged into an ordered data structure such as a dynamically allocated array.

Describing now samples of individual entities, we once again refer to FIG. 1. References 80, 80′, and 80″ are entity objects or data structure. FIG. 4 shows the details of an embodiment of an entity as a data structure or object. Ref, 81 is a reference to the entity set to which this entity belongs. Ref. 82 is a data structure or object representing the key attributes of this entity, whereas ref. 83 represents the non-key attributes. Ref. 84 are references to the relationships in which this entity is involves. Included are means for indicating which role in each such relationship this entity plays.

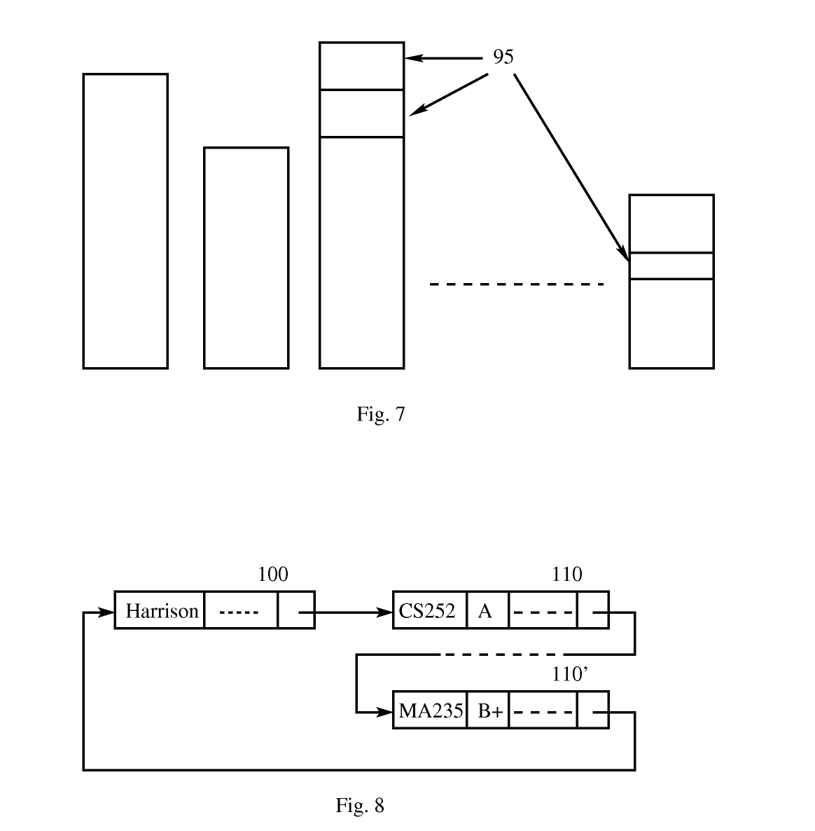

Ref. 90, 90′ in FIG. 1 are relationship objects or data structures. FIG. 7 details a relationship data structure or object. A relationship, in one embodiment, is represented by an array of array (all arrays are dynamically allocated). Each element of this array is represented as reference 95, and is actually called an “Entity-Plus” object, shown as references 88, 88′, 88″′ and 88″′ in FIG. 1. An Entity-Plus data structure or object comprises an entity data structure or object plus attributes pertaining to this entity as it enters into a particular relationship. These attributes are determined by both the particular entity and the particular relationship.

A simpler embodiment of relationship objects is possible, wherein at most one entity plays each role. Instead of having an entire array of “entity plus” objects representing each role, we use only one such object. This simpler embodiment will be represented as a separate set of claims.

Finally note that the database is value-oriented, as opposed to object-oriented, in the sense that the address of an entity is not part of the key, thus permitting value-comparison-based searches. To understand this last point it is important to note that there was a different meaning to the phrase “object-oriented” than the one currently used. See Ullman [2] in the “Other references” section. There, a database is object-oriented if the storage location of an entity can be used as the entity's key. The opposite of object-oriented is “value-oriented.” A database is value-oriented if an entity is identified only by attribute values. Relational databases are value-oriented, and its success relative to Network databases is due in a significant part to that fact. Learning from that success, ILE is meant to be value-oriented. It can be said that ILE has Relational DBMS's advantage of being value-orientedness, as well as Network DBMS's advantage of having links, although ILE's links are more direct than those of Network DBMS's.

I claim:

1. A method for storing a database involving data entities and relationships of any finite arity amongst said entities, comprising:
a. storing each said entity in a data structure, which could be an object, henceforth referred to as an entity object,
b. storing each said relationship amongst entities in a data structure, which could be an object, henceforth referred to as a relationship object,
c. for each said relationship, grouping zero, one, or more said entities that serve in each role of said relationship into a composite data structure such as a dynamically-allocated array,
d. linking with pointers or references each said relationship object with the appropriate members of said composite of entities involved in the relationship represented by said relationship object,
e. providing users or client programs with convenient and direct means of creating said entity objects and relationship objects without having to simulate or create said objects from other types of records.

2. The method of claim 1 wherein said entities of like kind are grouped together into entity sets, and said relationships of like kind are grouped together into relationship sets.

3. The method of claim 2 wherein, in each said entity, there exist links between the entity and all the relationships in which said entity is involved, and associated with each said link is a means by which the entity's role in the relationship can be identified.

4. The method of claim 3 wherein said means of role identification is implemented as a hash of hashes of dynamically-allocated arrays, where each hash element at the outer level represents links from said entity set to the relations in any one particular relationship set whose name would be the hash key.

5. The method of claim 4 wherein each hash element at the inner level represents a particular role played by said entity, and the role index would serve as the hash key.

6. The method of claim 5 wherein each array element represents one relationship, and in one embodiment these relationships are not sorted in any particular order in the array.

7. The method of claim 1 wherein a query language is provided as means for find (search) operations taking attributes and entity sets as parameters, such that it is not necessary to traverse the entire database or traverse entities in irrelevant entity sets to answer queries.

8. A method for storing a database involving data entities and relationships of any finite arity amongst said entities, comprising:
a. storing each said entity in a data structure or an object, henceforth referred to as an entity object,
b. storing each said relationship amongst entities in a data structure or an object, henceforth referred to as a relationship object,
c. linking with pointers or references in both directions each said relationship object with the entities involved in the relationship represented by said relationship object,
d. providing users or client programs with convenient and direct means of creating said entity objects and relationship objects without having to simulate or create said objects from other types of records.

9. The method of claim 8 wherein said entities of like kind are grouped together into entity sets, and said relationships of like kind are grouped together into relationship sets.

10. The method of claim 9 wherein, in each said entity, there exist links between the entity and all the relationships in which said entity is involved, and associated with each said link is a means by which the entity's role in the relationship can be identified.

11. The method of claim 8 wherein a query language is provided as means for find (search) operations taking attributes and entity sets as parameters, such that it is not necessary to traverse the entire database or traverse entities in irrelevant entity sets to answer queries.
